(19) United States
(12) Patent Application Publication
(10) Pub. No.: US 2014/0377514 A1
(43) Pub. Date: Dec. 25, 2014

(54) ELECTRONIC COMPONENT AND MANUFACTURING METHOD

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: WEN-CHIN LIN, New Taipei (TW); WEN-CHIEH WANG, New Taipei (TW); CHING-JOU CHEN, New Taipei (TW)

(21) Appl. No.: 14/311,367

(22) Filed: Jun. 23, 2014

(30) Foreign Application Priority Data
Jun. 24, 2013 (TW) 102122356

(51) Int. Cl. B32B 37/12; B32B 7/14; B32B 37/00

(52) U.S. Cl. CPC B32B 37/1292; B32B 37/0084; B32B 7/14
USPC 428/200; 156/291

(57) ABSTRACT

An electronic component includes a first article and a second article. The second article comprises a plurality of surface slots. The slots are filled with adhesives. The first article is attached to the second article by the adhesives, regions of the first article and the second article are in direct contact except for regions covered with adhesives.

### FIELD

The present disclosure relates to an electronic component and the manufacturing method thereof.

### BACKGROUND

To reduce thickness of an electronic component formed by joining two articles, insulating glues instead of soldering or other means of attachment are used to attach the two articles together. However, the insulating glue may change the conductivity of the electronic component, which may cause electromagnetic interference.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of an electronic component, the electronic component includes a first article and a second article.

FIG. 2 is an isometric view of the second article of FIG. 1 infilled with adhesive.

FIG. 3 is an assembled, isometric view of the electronic component of FIG. 1.

FIG. 4 is a cross-sectional view of the electronic component of FIG. 3, taken along the line IV-IV.

### DETAILED DESCRIPTION

The disclosure, including the accompanying drawing, is illustrated by way of examples and not by way of limitation. It should be noted that references to “an” or “one” embodiment in this disclosure are not necessarily to the same embodiment, and such references mean “at least one”.

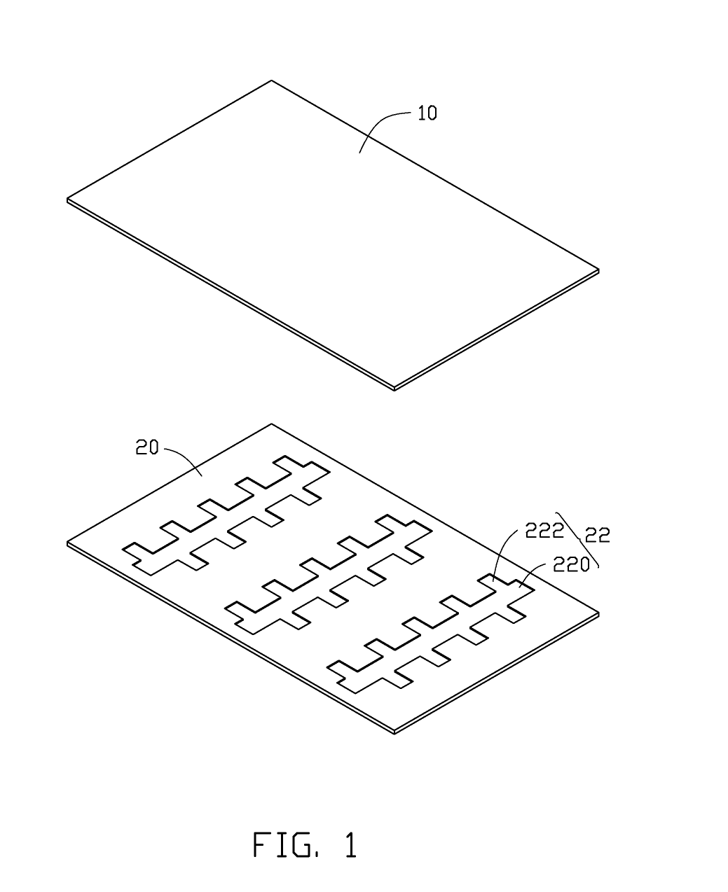

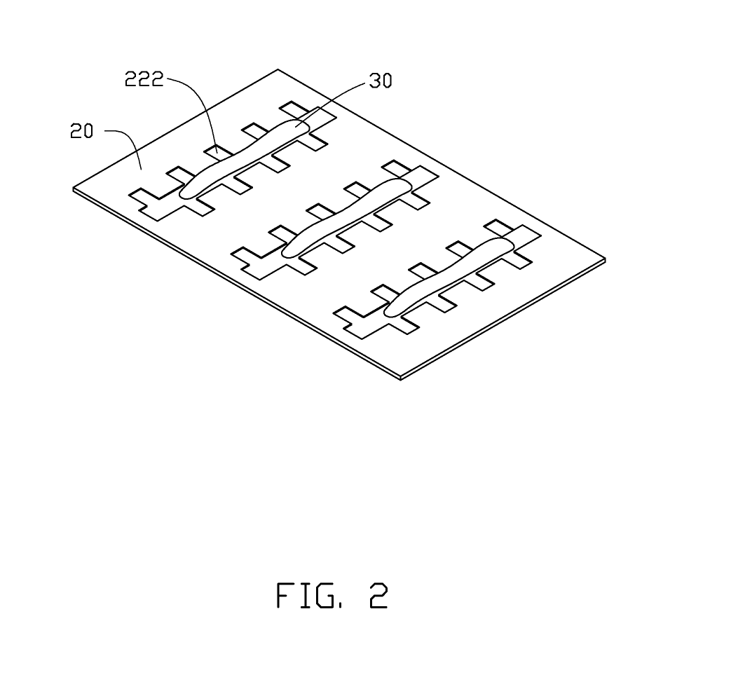

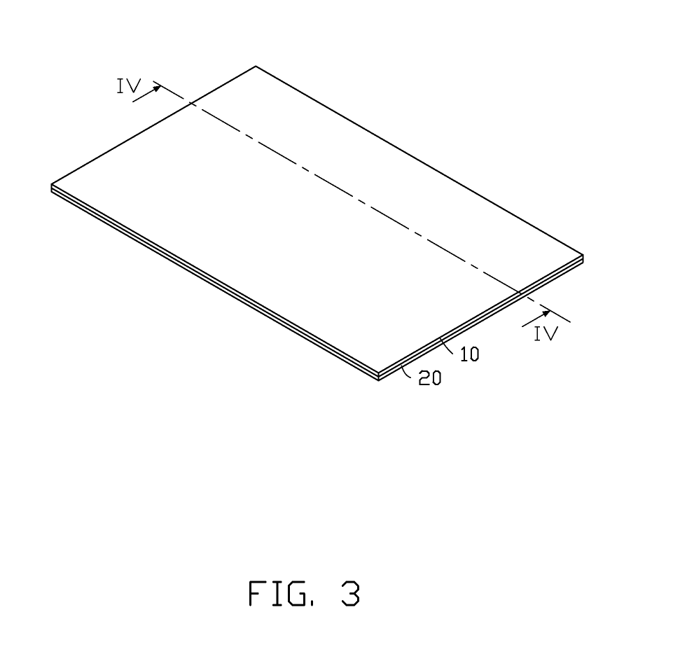

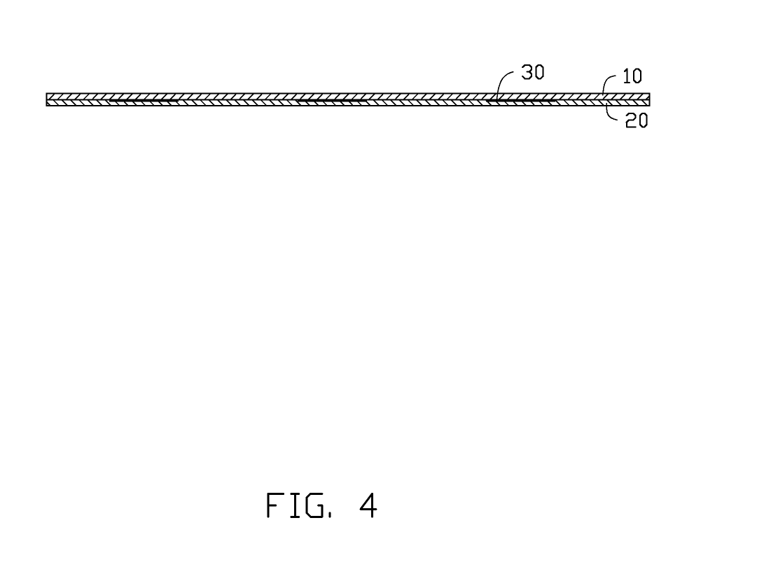

Referring to FIGS. 1 to 4, a method for manufacturing an electronic component includes following steps: providing a first article 10 and a second article 20; defining a plurality of slots 22 in the second article 20 by chemical or thermal process, each slot 22 includes an elongated main portion 220 and a plurality of branch portions 222 alternatively extending from opposite edges of the elongated main portion 220; evenly filling the elongated main portion 220 of the slots 22 with adhesive; attaching the first article 10 to the first side of the second article 20 to allow the adhesives to flow into the branch portions 222 from the elongated main portion 220. In this embodiment, the first article 10 and the second article 20 are flat; the first article 10 and the second article 20 are metal foils; each of the slots 22 has a depth of 200 μm; the adhesives are conductive nano-adhesives.

Regions of the first article 10 and the first side of the second article 20 make direct contact except for regions adhered with the adhesives 30. Thus, the thickness of the electronic component is decreased and the electronic component retains a good conductivity, which may reduce the electromagnetic interference.

It is to be understood, however, that even though numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. An electronic component, comprising:
a first article; and
a second article comprising a plurality of slots defined in a first side thereof, the slots filled with adhesives, the first article attached to the first side of the second article by the adhesives, first regions of the first article and the first side of the second article being in contact directly except for second regions of the first article adhered with adhesives.

2. The electronic component of claim 1, wherein each slot comprises an elongated main portion and a plurality of branch portions alternatively extending from two opposite side edges of the main portion.

3. The electronic component of claim 1, wherein the adhesives are nano-adhesives.

4. The electronic component of claim 1, wherein the first article and the second article are metal foils and the adhesives are conductive.

5. The electronic component of claim 1, wherein a depth of the slot is 200 μm.

6. A method for manufacturing an electronic component, comprising:
providing a first article and a second article;
defining a plurality of slots in a first side of the second article;
filled adhesives in the slots; and
attaching the first article to the first side of the second article by the adhesives, first regions of the first article and the second article being in contact directly except for second regions of the first article adhered with the adhesives.

7. The method of claim 6, wherein the slots are defined by chemical or thermal energy.

8. The method of claim 6, wherein each slot comprises an elongated main portion and a plurality of branch portions alternatively extending from two opposite side edges of the main portion.

9. The method of claim 6, wherein a depth of the slot is 200 μm.

10. The method of claim 6, wherein the adhesives are nano-adhesives.
